(19) United States
(12) Patent Application Publication
(10) Pub. No.: US 2013/0076720 A1
(43) Pub. Date: Mar. 28, 2013

(54) PIXEL GUARD LINES AND MULTI-GATE LINE CONFIGURATION

(71) Applicants: Ahmad AL-DAHLE, Santa Clara, CA (US); Wei Hsin Yao, Palo Alto, CA (US)

(72) Inventors: Ahmad AL-DAHLE, Santa Clara, CA (US); Wei Hsin Yao, Palo Alto, CA (US)

(21) Appl. No.: 13/243,938

(22) Filed: Sep. 23, 2011

(51) Int. Cl. G06F 3/038

(52) U.S. Cl. 345/212

(57) ABSTRACT

Data can be written to a sub-pixel by applying a voltage to the sub-pixel's data line. A large change in voltage on a data line can affect the voltages on adjacent data lines due to capacitive coupling between data lines. The resulting change in voltage on these adjacent data lines can give rise to visual artifacts in the data lines' corresponding sub-pixels. Various embodiments of the present disclosure serve to prevent or reduce the appearance of these visual artifacts by inserting guard lines between data lines to reduce the mutual capacitance between data lines. In other embodiments, a pixel having multiple gate lines can be used to selectively turn on and turn off different sub-pixels which, in turn, can reduce or eliminate the appearance of visual artifacts.

### FIELD OF THE DISCLOSURE

This relates generally to the reduction or elimination of visual artifacts that can appear when data is written to sub-pixels in display screens.

### BACKGROUND OF THE DISCLOSURE

Display screens of various types of technologies, such as liquid crystal displays (LCDs), organic light emitting diode (OLED) displays, etc., can be used as screens or displays for a wide variety of electronic devices, including such consumer electronics as televisions, computers, and handheld devices (e.g., cellular telephones, audio and video players, gaming systems, and so forth). LCD devices, for example, typically provide a flat display in a relatively thin package that is suitable for use in a variety of electronic goods. In addition, LCD devices typically use less power than comparable display technologies, making them suitable for use in battery-powered devices or in other contexts where it is desirable to minimize power usage.

LCD devices typically include multiple picture elements (pixels) arranged in a matrix. The pixels may be driven by scanning line and data line circuitry to display an image on the display that can be periodically refreshed over multiple image frames such that a continuous image may be perceived by a user. Individual pixels of an LCD device can permit a variable amount light from a backlight to pass through the pixel based on the strength of an electric field applied to the liquid crystal material of the pixel. The electric field can be generated by a difference in potential of two electrodes, a common electrode and a pixel electrode. In many displays, the direction of the electric field generated by the two electrodes can be reversed periodically by switching the polarities of the voltages applied to the common electrode and pixel electrode in accordance with a write sequence. Reversing the polarities of these electrodes, however, can create a large change in voltage applied to various lines in the display, such as the data lines used to charge the pixel electrodes to a target voltage. Due to capacitive coupling between data lines, this large change in voltage can affect the voltage on data lines in adjacent pixel electrodes which can give rise to visual artifacts in the display.

### SUMMARY

Data can be written to a sub-pixel by applying a voltage to the sub-pixel's data line. A large change in voltage on a data line can affect the voltages on adjacent data lines due to capacitive coupling between data lines. The resulting change in voltage on these adjacent data lines can give rise to visual artifacts in the data lines' corresponding sub-pixels.

Various embodiments of the present disclosure serve to prevent or reduce the appearance of these visual artifacts by inserting guard lines between data lines to reduce the mutual capacitance between data lines. In other embodiments, a pixel having multiple gate lines can be used to selectively turn on and turn off different sub-pixels which, in turn, can reduce or eliminate the appearance of visual artifacts.

### BRIEF DESCRIPTION OF THE DRAWINGS

FIG. 1A illustrates an example mobile telephone according to embodiments of the disclosure.

FIG. 1B illustrates an example digital media player according to embodiments of the disclosure.

FIG. 1C illustrates an example personal computer according to embodiments of the disclosure.

FIG. 1D illustrates an example display screen according to embodiments of the disclosure.

FIG. 2 illustrates an example thin film transistor (TFT) circuit according to embodiments of the disclosure.

FIG. 3A illustrates an example one-column inversion scheme according to embodiments of the disclosure.

FIG. 3B illustrates an example two-column inversion scheme according to embodiments of the disclosure.

FIG. 3C illustrates an example three-column inversion scheme according to embodiments of the disclosure.

FIGS. 4A, 4B, and 4C illustrate an example alternating voltage polarity pattern according to an embodiment of a column inversion scheme.

FIG. 5A illustrates example pixels with guard lines according to embodiments of the disclosure.

FIG. 5B illustrates an example pixel with guard lines during a write sequence according to embodiments of the disclosure.

FIG. 6 illustrates an example TFT circuit according to embodiments of the disclosure.

FIG. 7 is a block diagram of an example computing system that illustrates one implementation of an example display screen according to embodiments of the disclosure.

### DETAILED DESCRIPTION

In the following description of exemplary embodiments, reference is made to the accompanying drawings in which it is shown by way of illustration, specific embodiments of the disclosure. It is to be understood that other embodiments can be used and structural changes can be made without departing from the scope of the embodiments of the disclosure.

Furthermore, although embodiments of the disclosure may be described and illustrated herein in terms of logic performed within a display driver, host video driver, etc., it should be understood that embodiments of the disclosure are not so limited, but can also be performed within a display subassembly, liquid crystal display driver chip, or within another module in any combination of software, firmware, and/or hardware.

Various embodiments of the disclosure use guard lines and a multi-gate line configuration to reduce or eliminate the appearance of visual artifacts when data is written to a row of sub-pixels. Write sequences can control the sequence in which voltage is applied to each sub-pixel's data lines. In some scanning operations of display screens, such as some liquid crystal display inversion schemes, a large change in voltage on a data line can affect the voltages on adjacent data lines due to capacitive coupling between data lines. The resulting change in voltage on these adjacent data lines can give rise to visual artifacts in the data lines' corresponding sub-pixels. In some embodiments, guard lines can be inserted between data lines to reduce the mutual capacitance between data lines. In other embodiments, a pixel having multiple gate lines can be used to selectively turn on and turn off different sub-pixels which, in turn, can reduce or eliminate the appearance of visual artifacts.

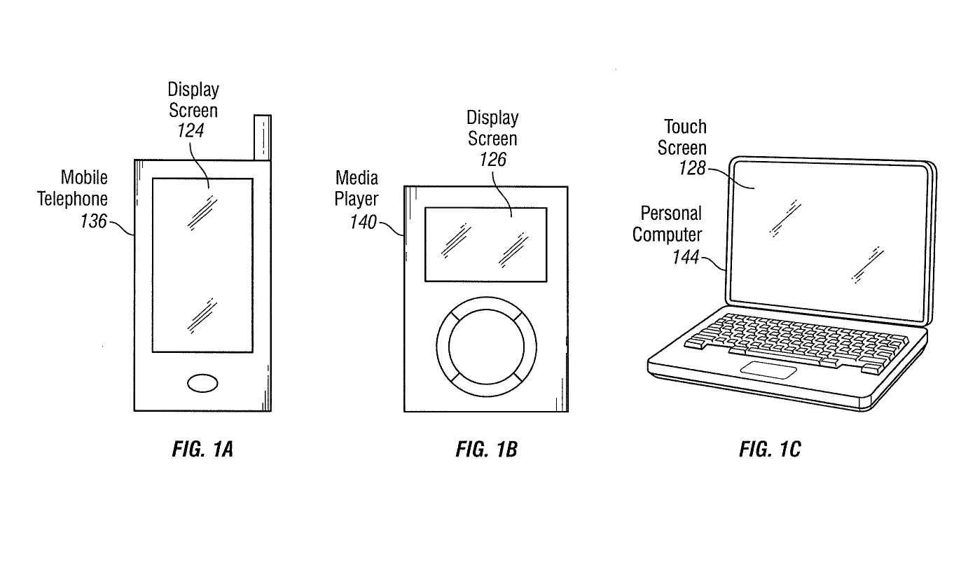

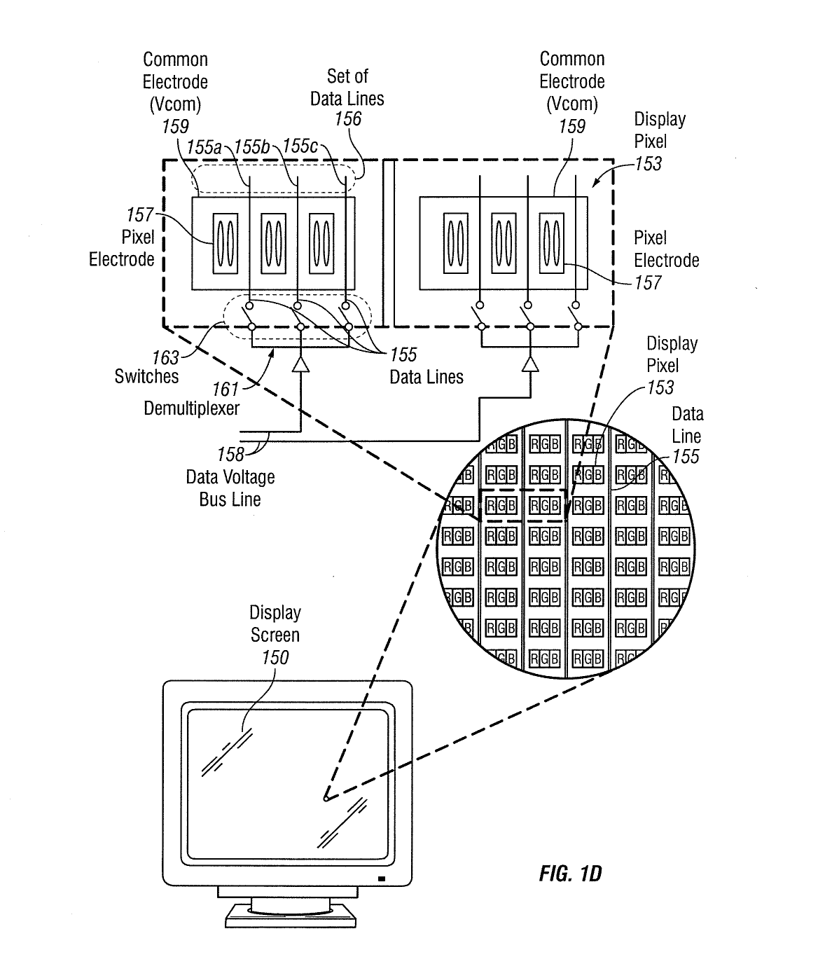

FIGS. 1A-1D show example systems in which display screens (which can be part of touch screens) according to embodiments of the disclosure may be implemented. FIG. 1A illustrates an example mobile telephone 136 that includes a display screen 124. FIG. 1B illustrates an example digital media player 140 that includes a display screen 126. FIG. 1C illustrates an example personal computer 144 that includes a display screen 128. FIG. 1D illustrates an example display screen 150, such as a stand-alone display. In some embodiments, display screens 124, 126, 128, and 150 can be touch screens in which touch sensing circuitry can be integrated into the display pixels. Touch sensing can be based on, for example, self capacitance or mutual capacitance, or another touch sensing technology. In some embodiments, a touch screen can be multi-touch, single touch, projection scan, full-imaging multi-touch, or any capacitive touch.

In some scanning methods, the direction of the electric field across the pixel material can be reversed periodically. In LCD displays, for example, periodically switching the direction of the electric field can help prevent the molecules of liquid crystal from becoming stuck in one direction. Switching the electric field direction can be accomplished by reversing the polarity of the electrical potential between the pixel electrode and the Vcom. In other words, a positive potential from the pixel electrode to the Vcom can generate an electric field across the liquid crystal in one direction, and a negative potential from the pixel electrode to the Vcom can generate an electric field across the liquid crystal in the opposite direction. In some scanning methods, switching the polarity of the potential between the pixel electrode and the Vcom can be accomplished by switching the polarities of the voltages applied to the pixel electrode and the Vcom. For example, during an update of an image in one frame, a positive voltage can be applied to the pixel electrode and a negative voltage can be applied to the Vcom. In a next frame, a negative voltage can be applied to the pixel electrode and a positive voltage can be applied to the Vcom. One skilled in the art would understand that switching the polarity of the potential between the pixel electrode and the Vcom can be accomplished without switching the polarity of the voltage applied to either or both of the pixel electrode and Vcom. In this regard, although example embodiments are described herein as switching the polarity of voltages applied to data lines, and correspondingly, to pixel electrodes, it should be understood that in some embodiments the voltage applied to data lines can be switched between high and low voltages of the same polarity. For example, in some embodiments, a negative polarity potential can be created between the pixel electrode and the Vcom by applying a low positive voltage to the pixel electrode and a high positive voltage to the Vcom, and a positive polarity potential can be created between the pixel electrode and the Vcom by applying a high positive voltage to the pixel electrode and a low positive voltage to the Vcom.

FIG. 1D illustrates some details of an example display screen 150. FIG. 1D includes a magnified view of display screen 150 that shows multiple display pixels 153, each of which can include multiple display sub-pixels, such as red (R), green (G), and blue (B) sub-pixels in an RGB display, for example. Data lines 155 can run vertically through display screen 150, such that a set 156 of three data lines (an R data line 155a, a G data line 155b, and a B data line 155c) can pass through an entire column of display pixels (e.g., vertical line of display pixels).

FIG. 1D also includes a magnified view of two of the display pixels 153, which illustrates that each display pixel can include pixel electrodes 157, each of which can correspond to one of the sub-pixels, for example. Each display pixel can include a common electrode (Vcom) 159 that can be used in conjunction with pixel electrodes 157 to create an electrical potential across a pixel material (not shown). Varying the electrical potential across the pixel material can correspondingly vary an amount of light emanating from the sub-pixel. In some embodiments, for example, the pixel material can be liquid crystal. A common electrode voltage can be applied to a Vcom 159 of a display pixel, and a data voltage can be applied to a pixel electrode 157 of a sub-pixel of the display pixel through the corresponding data line 155. A voltage difference between the common electrode voltage applied to Vcom 159 and the data voltage applied to pixel electrode 157 can create the electrical potential through the liquid crystal of the sub-pixel. The electrical potential can generate an electric field through the liquid crystal, which can cause inclination of the liquid crystal molecules to allow polarized light from a backlight (not shown) to emanate from the sub-pixel with a luminance that depends on the strength of the electric field (which can depend on the voltage difference between the applied common electrode voltage and data voltage). In other embodiments, the pixel material can include, for example, a light-emitting material, such as can be used in organic light emitting diode (OLED) displays.

In this example embodiment, the three data lines 155 in each set 156 can be operated sequentially. For example, a display driver or host video driver (not shown) can multiplex an R data voltage, a G data voltage, and a B data voltage onto a single data voltage bus line 158 in a particular sequence, and then a demultiplexer 161 in the border region of the display can demultiplex the R, G, and B data voltages to apply the data voltages to data lines 155a, 155b, and 155c in the particular sequence. Each demultiplexer 161 can include three switches 163 that can open and close according to the particular sequence of sub-pixel charging for the display pixel. In an R-G-B sequence, for example, data voltages can be multiplexed onto data voltage bus line 158 such that R data voltage is applied to R data line 155a during a first time period, G data voltage is applied to G data line 155b during a second time period, and B data voltage is applied to B data line 155c during a third time period. Demultiplexer 161 can demultiplex the data voltages in the particular sequence by closing switch 163 associated with R data line 155a during the first time period when R data voltage is being applied to data voltage bus line 158, while keeping the green and blue switches open such that G data line 155b and B data line 155c are at a floating potential during the application of the R data voltage to the R data line. In this way, for example, the red data voltage can be applied to the pixel electrode of the red sub-pixel during the first time period. During the second time period, when G data voltage is being applied to G data line 155b, demultiplexer 161 can open the red switch 163, close the green switch 163, and keep the blue switch 163 open, thus applying the G data voltage to the G data line, while the R data line and B data line are floating. Likewise, the B data voltage can be applied during the third time period, while the G data line and the R data line are floating.

As will be described in more detail below with respect to example embodiments, applying a data voltage to a data line can affect the voltages on surrounding, floating data lines. In some cases, the effect on the voltages of floating data lines can affect the luminance of the sub-pixels corresponding to the affected data lines, causing the sub-pixels to appear brighter or darker than intended. The resulting increase or decrease in sub-pixel luminance can be detectable as a visual artifact in some displays.

In some embodiments, thin film transistors (TFTs) can be used to address display pixels, such as display pixels 153, by scanning lines of display pixels (e.g., rows of display pixels) in a particular order. When each line is updated during the scan of the display, data voltages corresponding to each display pixel in the updated line can be applied to the set of data lines of the display pixel through the demuxing procedure described above, for example.

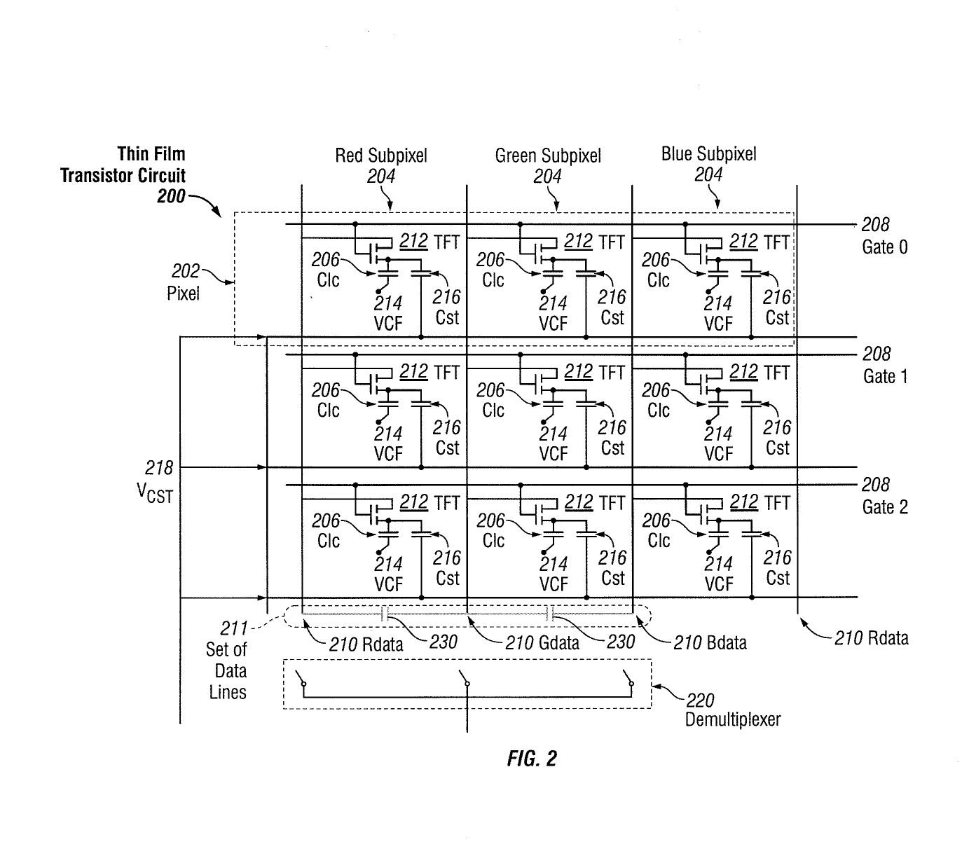

FIG. 2 illustrates a portion of an exemplary TFT circuit 200 according to embodiments of the present disclosure. As shown by the figure, the thin film transistor circuit 200 can include multiple pixels 202 arranged into rows, or scan lines, with each pixel 202 containing a set of color sub-pixels 204 (red, green, and blue, respectively). It is understood that a plurality of pixels can be disposed adjacent each other to form a row of the display. Each color reproducible by the liquid crystal display can therefore be a combination of three levels of light emitted from a particular set of color sub-pixels 204.

Color sub-pixels may be addressed using the thin film transistor circuit's 200 array of scan lines (called gate lines 208) and data lines 210. Gate lines 208 and data lines 210 formed in the horizontal (row) and vertical (column) directions, respectively, and each column of display pixels can include a set 211 of data lines including an R data line, a G data line, and a B data line. Each sub-pixel may include a pixel TFT 212 provided at the respective intersection of one of the gate lines 208 and one of the data lines 210. A row of sub-pixels may be addressed by applying a gate signal on the row's gate line 208 (to turn on the pixel TFTs of the row), and by applying voltages on the data lines 210 corresponding to the amount of emitted light desired for each sub-pixel in the row. The voltage level of each data line 210 may be stored in a storage capacitor 216 in each sub-pixel to maintain the desired voltage level across the two electrodes associated with the liquid crystal capacitor 206 relative to a voltage source 214 (denoted here as Vcf). A voltage Vcf may be applied to the counter electrode (common electrode) forming one plate of the liquid crystal capacitance with the other plate formed by a pixel electrode associated with each sub-pixel. One plate of each of the storage capacitors 216 may be connected to a common voltage source Cst along line 218.

Applying a voltage to a sub-pixel's data line can charge the sub-pixel (e.g., the pixel electrode of the sub-pixel) to the voltage level of the applied voltage. Demultiplexer 220 in the border region of the display can be used to apply the data voltages to the desired data line. For example, demultiplexer 220 can apply data voltages to the R data line, the G data line, and the B data line in a set 211 in a particular sequence, as described above with reference to FIG. 1D. Therefore, while a voltage can be applied to one data line (e.g., red), the other data lines (e.g., green and blue) in the pixel can be floating. However, applying a voltage to one data line can affect the voltage on floating data lines, for example, because a capacitance 230 existing between data lines can allow voltage changes on one data line to be coupled to other data lines. This capacitive coupling can change the voltage on the floating data lines, which can make the sub-pixels corresponding to the floating data lines appear either brighter or darker depending on whether the voltage change on the charging data line is in the same direction or opposite direction, respectively, as the polarity of the floating data line voltage. In addition, the amount of voltage change on the floating data line can depend on the amount of the voltage change on the charging data line.

By way of example, a negative data voltage, e.g., −2V, may be applied to data line A during the scan of a first row of sub-pixels. Then, during the scan of the next row of sub-pixels, a positive data voltage, e.g., +2V, may be applied to data line A, thus swinging the voltage on data line A from −2V to +2V, i.e., a positive voltage change of +4V. Voltages on floating data lines surrounding data line A can be increased by this positive voltage swing. For example, the positive swing on data line A can increase the voltage of an adjacent data line B floating at a positive voltage, thus, increasing the magnitude of the positive floating voltage and making the sub-pixel corresponding to data line B appear brighter. Likewise, the positive voltage swing on data line A can increase the voltage of an adjacent data line C floating at a negative voltage, thus decreasing the magnitude of the negative floating voltage and making the sub-pixel corresponding to sub-pixel C appear darker. Thus, the appearance of visual artifacts of brighter or darker sub-pixels can depend on, for example, the occurrence of large voltage changes on one or more data lines during scanning of a display and the polarity of surrounding data lines with floating voltages during the large voltage changes.

The appearance of visual artifacts can be described in greater detail with reference to an example write sequence in a column inversion scheme. Although the following description is specific to a column inversion scheme, a person of ordinary skill in the art would recognize that visual artifacts can also appear in other inversion schemes including, for example, a line (row) inversion scheme, a reordered line (row) inversion scheme, or a dot inversion scheme.

In a column inversion scheme, the polarity of the voltage applied to each data line can alternate across a scanned row of sub-pixels. That is during a scan of one row, positive polarity data voltages can be applied to some of the data lines and negative polarity data voltages can be applied to the other data lines.

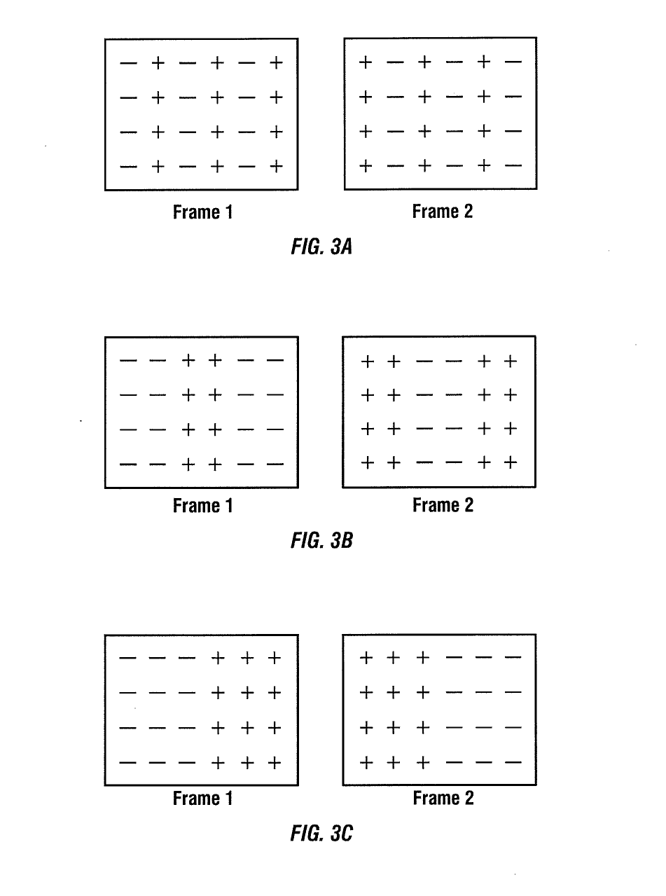

This alternating pattern is illustrated in FIG. 3A which shows columns with voltages of alternating polarities. The polarity of the voltage can remain the same along a column but alternate across a row. Other column inversion schemes, including two-column inversion illustrated in FIG. 3B, and three-column inversion illustrated in FIG. 3C, can operate according to similar principles.

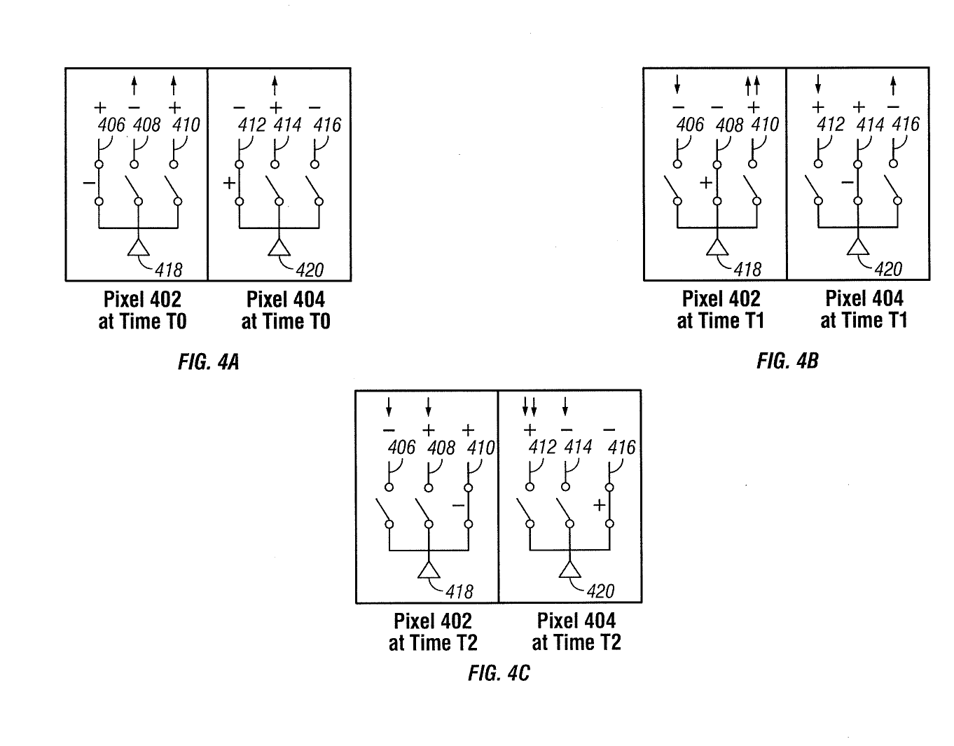

FIGS. 4A, 4B, and 4C illustrate an example write sequence applied across a scanned row in one embodiment of a column inversion scheme. FIGS. 4A, 4B, and 4C illustrate two adjacent pixels 402 and 404 along the same row at different points in time, T0, T1, and T2, during a scan of the row. Pixel 402 has a red sub-pixel with red data line 406, a green sub-pixel with green data line 408, and a blue sub-pixel with blue data line 410. A demultiplexer 418 located in the border region of the display can operate the data lines of pixel 402. The demultiplexer receives the RGB data signals for each sub-pixel and feeds each signal to the appropriate RGB data line at the appropriate timing as dictated by timing and control circuitry (not shown), for example, as described above. Pixel 404 similarly has a red data line 412, a green data line 414, a blue data line 416, and a demultiplexer 420. Although writing, i.e., application of data voltages to the data lines, may occur in any sequence, the embodiment shown in FIGS. 4A, 4B, and 4C uses an RGB write sequence for each sub-pixel.

The RGB write sequence first writes data to each red sub-pixel in the row at time T0; next writes data to each green sub-pixel in the row at time T1; and finally writes data to each blue sub-pixel in the row at time T2. To accomplish this writing sequence, demultiplexers select the desired sub-pixel for writing, while a voltage can then be applied to the sub-pixel's corresponding data line. As shown in FIGS. 4A, 4B, and 4C, a “+” or “−” is located above each sub-pixel data line. These signs represent the polarity of the sub-pixel's data line voltage from the previous update. The “+” or “−” sign next to the closed switch represents the polarity of the voltage being applied to the data line. In the present example, pixels 402 and 404 may be in the first row scanned in a frame. In this example, the polarity of the data voltages can be reversed in between the previous frame and the new frame. Therefore, the “+” or “−” sign above each sub-pixel data line shows the prior voltage polarity from the previous update. This polarity is opposite to the polarity of the voltage applied in the current update. In this case, the data line voltages applied in the scan of this first row can result in a large voltage change in each data line, as the voltage on each data line can swing from + to − or from − to +.

FIG. 4A, for example, illustrates the writing of data to the red sub-pixels by application of voltage to red data lines 406 and 412 at time T0. As illustrated, demultiplexers 418 and 420 can apply voltage to the red data lines. Doing so can change the polarity of the voltages on red data line 406 from + to − and from − to + on red data line 412. Because the voltages applied to the red data lines can swing the data line voltages from one polarity to the opposite polarity, the voltage change on the red data lines can be large. While a voltage is being applied to the red data lines, the green and blue data lines can be floating. The large voltage change on the red data lines can affect the voltages on other data lines, for example, due to capacitive coupling between data lines. In particular, the capacitance existing between two data lines can allow voltage changes on one data line to affect the voltages on other data lines. While there may be some amount of capacitance existing between a particular data line and each and every other data line, the amount of capacitance can vary depending on the distance between two data lines and may be greatest between two adjacent data lines. Accordingly, the following discussion can ignore the impact on non-adjacent data lines.

Here, the voltage on red data line 406 can swing from a positive polarity to a negative polarity: The negative change in voltage can affect the negative voltage on green data line 408 because a mutual capacitance can exist between red data line 406 and green data line 408. Because the voltage on green data line 408 is negative, the negative change in voltage on red data line 406 can increase the magnitude of the negative voltage on green data line 408. Accordingly, the sub-pixel corresponding to green data line 408 can brighten. This brightening effect is represented by the upward pointing arrow above green data line 408. Although the negative change in voltage can also affect the voltage on blue data line 410, the blue data line is not adjacent to the red data line. As such, the impact on blue data line 410 can be ignored.

With respect to red data line 412, the swing in voltage from a negative polarity to a positive polarity can affect the voltage on green data line 414 because a mutual capacitance can exist between red data line 412 and green data line 414. Because the voltage on green data line 414 has a positive polarity, the positive change in voltage on red data line 412 can increase the magnitude of the voltage on green data line 414, which can cause the corresponding green sub-pixel to brighten. This brightening effect is represented by the upward pointing arrow above green data line 414. Similarly, the positive change in voltage on red data line 412 can increase the magnitude of the positive voltage on blue data line 410 in adjacent pixel 402, which can cause the corresponding blue sub-pixel to appear brighter. The impact on non-adjacent blue data line 416 can be ignored.

FIG. 4B illustrates the writing of data to the green sub-pixels by application of voltage to green data lines 408 and 414 at time T1. As illustrated, demultiplexers 418 and 420 can apply voltage to the green data lines. Doing so can change the polarity of the voltage on green data line 408 from − to + and the polarity of the voltage on green data line 414 from + to −. The application of voltages to green data lines 408 and 414 can overwrite any changes in voltage that occurred on the green data lines before time T1. This overwriting is represented by the absence of the upward pointing arrows above green data lines 408 and 414.

The large voltage change on the green data lines can affect the voltages on the red and blue data lines because a mutual capacitance can exist between the green data lines and the red data lines and between the green data lines and the blue data lines. In this example, the large positive voltage change on green data line 408 can result from the swing in the polarity from − to +. This large positive voltage change can cause a positive voltage change in red data line 406. Because the voltage polarity of red data line 406 is negative, the positive voltage change on green data line 408 can reduce the magnitude of the red data line 406 voltage, which can make the corresponding red sub-pixel appear darker. This darkening effect is represented by the downward pointing arrow above red data line 406. The large positive voltage change on green data line 408 can increase the magnitude of the positive voltage on blue data line 410, which can cause the corresponding blue sub-pixel to appear brighter. This brightening effect is represented by the upward pointing arrow above blue data line 410. As illustrated in FIG. 4B, two upward pointing arrows appear above blue data line 410 because the corresponding blue sub-pixel can brighten first at time T0 and again at time T1.

The change in voltage on green data line 414 can affect the voltage on red data line 412 and blue data line 416. With respect to red data line 412, the large negative change in voltage on green data line 414 can decrease the magnitude of the positive voltage on red data line 412, which can make the corresponding red sub-pixel appear darker as represented by the downward pointing arrow. With respect to blue data line 416, the large negative change in voltage on green data line 414 can increase the magnitude of the negative voltage on blue data line 416, which can make corresponding blue sub-pixel appear brighter as represented by the upward pointing arrow.

FIG. 4C illustrates the writing of data to the blue sub-pixels by application of voltage to blue data lines 410 and 416. Just as above, demultiplexers 418 and 420 can apply voltage to the blue data lines. Doing so changes the polarity of the voltages on the blue data lines from + to − on data line 410 and from − to + on data line 416. The application of voltages to blue data lines 410 and 416 can overwrite any changes in voltage that occurred on the blue data lines before time T2. This overwriting is represented by the absence of the upward pointing arrows above blue data lines 410 and 416.

The change in voltage on blue data line 410 can affect the voltage on green data line 408 and red data line 412 in adjacent pixel 404. Although the change in voltage on blue data line 410 can also affect the voltage on non-adjacent red data line 406, this impact can be ignored. With respect to green data line 408, the large negative change in voltage on blue data line 410 can cause a negative voltage change on green data line 408 because a mutual capacitance can exist between blue data line 410 and green data line 408. Because the polarity of green data line 408 is positive, the negative voltage change can reduce the magnitude of the green data line voltage, which can make the green sub-pixel appear darker as represented by the downward pointing arrow. With respect to red data line 412, the large negative voltage change on blue data line 410 can reduce the magnitude of the positive voltage on red data line 412 in the adjacent pixel, which can make the red sub-pixel appear darker as represented by the downward pointing arrow. As illustrated in FIG. 4C, two downward pointing arrows appear above red data line 412 because the corresponding red sub-pixel can darken first at time T1 and again at time T2.

In a similar fashion, the large positive change in voltage on blue data line 416 can change the voltage on green data line 414. This positive voltage change can reduce the magnitude of the negative voltage on green data line 414, which can make the green sub-pixel appear darker as represented by the downward pointing arrow.

As illustrated by the downward pointing arrows above red data lines 406 and 412 and green data lines 408 and 414 in FIG. 4C, visual artifacts can appear in the data lines' corresponding sub-pixels when the RGB write sequence is used with the illustrated column inversion scheme.

Visual artifacts can appear when a large change in voltage on a data line affects the voltages on adjacent data lines due to capacitive coupling between data lines. The resulting change in voltage on these adjacent data lines can give rise to visual artifacts in the data lines' corresponding sub-pixels. Various embodiments of the present disclosure serve to prevent or reduce the appearance of these visual artifacts by adding guard lines to each pixel. In other embodiments, a TFT circuit having a multi-gate line configuration can be used.

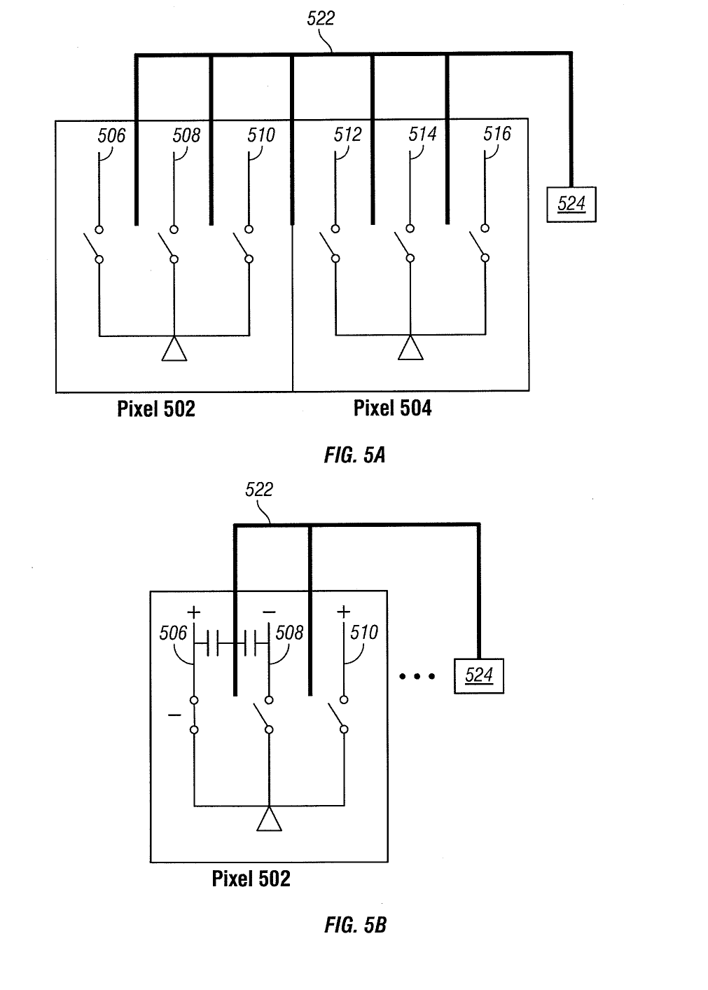

In an exemplary embodiment, guard lines can be added to the pixels to reduce unwanted capacitive coupling between data lines. FIG. 5A illustrates two adjacent pixels 502 and 504 along the same row. Pixel 502 has a red sub-pixel with red data line 506, a green sub-pixel with green data line 508, and a blue sub-pixel with blue data line 510. Pixel 504 has a similar structure as pixel 502 and includes a red sub-pixel with red data line 512, a green sub-pixel with green data line 514, and a blue sub-pixel with blue data line 516.

Pixels 502 and 504 can include guard lines 522. In an exemplary embodiment, a guard line 522 can be disposed between each of the data lines within a pixel. For example, in pixel 502, guard lines 522 can be disposed between red data line 506 and green data line 508 and between green data line 508 and blue data line 510. In pixel 504, guard lines 522 can be disposed between red data line 512 and green data line 514 and between green data line 514 and blue data line 516. A guard line 522 can also be disposed between pixels 502 and 504 such that the guard line lies between blue data line 510 and red data line 512. Each guard line 522 can be an electrically conductive electrode that can be connected to a reference potential 524. In some embodiments, this reference potential can be connected to ground or AC ground.

Guard lines 522 can reduce unwanted capacitive coupling between data lines. FIG. 5B illustrates the application of a negative voltage to red data line 506 in pixel 502. The application of a negative voltage to red data line 506 can swing the voltage on the data line from positive to negative. In a device that does not include a guard line, such as in the example of FIG. 4A, the large negative change in voltage on red data line 506 can increase the magnitude of the negative voltage on adjacent green data line 508 because of the mutual capacitance between red data line 506 and green data line 508. This change in voltage on green data line 508 can result in a brightening of the corresponding green sub-pixel.

In the present example of FIGS. 5A and 5B, guard line 522 can reduce or eliminate the appearance of the visual artifact in the green sub-pixel. Guard line 522 can be connected to reference potential 524 which can, for example, be connected to ground or AC ground. By placing guard line 522 between red data line 506 and green data line 508, guard line 522 can reduce the mutual capacitance between these data lines. The reduction of mutual capacitance between data lines can occur because guard line 522 can shield some of the electric field that can be generated between the data lines, which is illustrated in FIG. 5B as a capacitance between red data line 506 and guard line 522 and between guard line 522 and green data line 508. Guard line 522 can be formed such that its length is long enough to shield the electric field lines that can be generated between the data lines. Because the mutual capacitance between red data line 506 and green data line 508 can be reduced, the large swing in voltage on red data line 506 may not affect the voltage on green data line 508 and, consequently, may reduce or eliminate the appearance of a visual artifact in the corresponding green sub-pixel.

Although the exemplary embodiment of FIG. 5B illustrates the use of a guard line in a single pixel, guard lines can also be used in every pixel in the touch sensor panel (or a subset thereof).

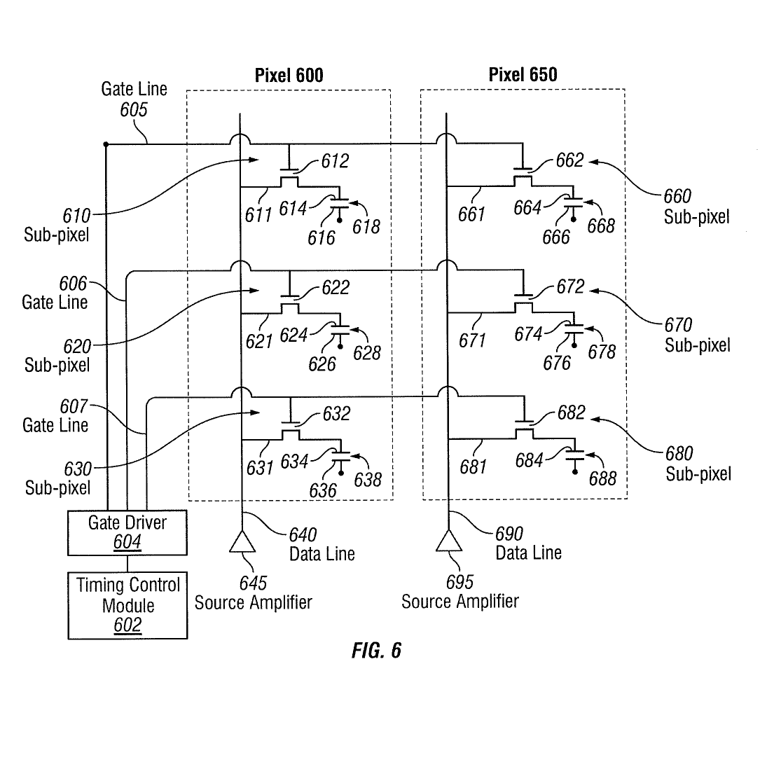

In another exemplary embodiment, a TFT circuit having a multi-gate line configuration for each pixel can be used to prevent or reduce the appearance of visual artifacts. A portion of this exemplary TFT circuit according to embodiments of the disclosure is illustrated in FIG. 6. This TFT circuit illustrates two pixels 600 and 650 each having a set of colored sub-pixels. The structure of pixel 600 and its sub-pixels is described below. A description of pixel 650 and its sub-pixels is omitted as these components are structurally similar to pixel 600 and its sub-pixels.

Pixel 600 can contain a set of colored sub-pixels 610, 620, and 630 (for example, a red sub-pixel, a green sub-pixel, and a blue sub-pixel, respectively). Sub-pixel 610 can have a liquid crystal capacitor 618 and a pixel TFT 612. Liquid crystal capacitor 618 can be associated with a pixel electrode 614 and a common electrode 616. Common electrode 616 can be connected to a voltage source (not shown). Pixel electrode 614 can be connected to pixel TFT 612. Pixel TFT 612 can be connected to data line 640 at its source terminal via data line extension 611. Pixel TFT 612 can be connected to gate line 605 at its gate terminal. Source amplifier 645 can apply a voltage to data line 640 to write data to sub-pixel 610. Gate line 605 can be connected to a gate driver 604 which, in turn, can be connected to a timing control module 602. In some embodiments, timing control module 602 can be implemented as part of a display driver.

Similar to sub-pixel 610, sub-pixels 620 and 630 can each have a pixel TFT (622, 632) and a liquid crystal capacitor (628, 638) composed of a pixel electrode (624, 634) and a common electrode (626, 636). Pixel TFTs 622 and 632 can both be connected to data line 640 at their source terminals via data line extensions 621 and 631. Pixel TFTs 622 and 632 can also be connected to gate driver 604 via gate lines 606 and 607, respectively.

The operation of the illustrated TFT circuit can be explained with reference to an example write sequence. In this example, data can be written to sub-pixels 610 and 660 at a first point in time T0 and subsequently written to sub-pixels 620 and 670 at a second point in time T1. Although data can also be written to sub-pixels 630 and 680, this description is omitted from this example as a person of ordinary skill in the art would understand how to write data to sub-pixels 630 and 680 based on the following description.

Data can be written to sub-pixels 610 and 660 by turning pixel TFTs 612 and 662, respectively, on and applying a target voltage to data lines 640 and 690, respectively. In order to turn pixel TFTs 612 and 662 on, timing control module 602 can generate a control signal. This control signal can, for example, be a clock pulse that indicates what pixel TFT should be turned on. Based on this control signal, gate driver 604 can apply a voltage on gate line 605. This voltage can, for example, be a high gate line voltage. Because gate line 605 is connected to pixel TFTs 612 and 662, application of the high gate line voltage to gate line 605 can turn both pixel TFTs on.

Once pixel TFT 612 is turned on, source amplifier 645 can apply a target voltage to data line 640. This target voltage can reach the source terminal of pixel TFT 612 via data line extension 611. Because the voltage on gate line 605 can turn pixel TFT 612 on, the target voltage at the source terminal of pixel TFT 612 can conduct through the transistor to pixel electrode 614.

As source amplifier 645 applies a target voltage to data line 640, source amplifier 695 can apply a target voltage to data line 690 at substantially the same time. This target voltage can reach the source terminal of pixel TFT 662 via data line extension 661. Because the voltage on gate line 605 can also turn pixel TFT 662 on, the target voltage at the source terminal of pixel TFT 662 can conduct through the transistor to pixel electrode 664.

A voltage source (not shown) can apply a voltage to common electrodes 616 and 666. The difference in voltage across liquid crystal capacitors 618 and 668 can generate electric fields through the liquid crystal which can cause inclination of the liquid crystal molecules. This inclination can vary the amount of polarized light that can pass through the liquid crystal molecules which can vary the luminance of sub-pixels 610 and 660.

When timing control module 602 generates the control signal described above, the control signal can also indicate that the pixel TFTs associated with sub-pixels 620, 630, 670, and 680 should be turned off. As explained above, gate driver 604 can apply a high gate line voltage to turn on the pixel TFTs associated with sub-pixels 610 and 660. To turn off the pixel TFTs associated with sub-pixels 620, 630, 670, and 680, gate driver 604 can apply a different voltage to gate lines 606 and 607. This voltage can, for example, be a low gate line voltage. By turning a pixel TFT off, the data voltage applied to a source terminal of the pixel TFT cannot conduct through the transistor and onto an adjacent pixel electrode. For example, when pixel TFT 680 is turned off, the target voltage applied to data line 690 and data line extension 681 cannot conduct through the transistor to pixel electrode 684 of liquid crystal capacitor 688.

Consequently, while data is written to the sub-pixels along gate line 605 (i.e., sub-pixels 610 and 660) at time T0, the sub-pixels along gate lines 606 (i.e., sub-pixels 620 and 670) and 607 (i.e., sub-pixels 630 and 680) can be turned off. Although the preceding paragraph describes the use of a high gate line voltage to turn a pixel TFT on and a low gate line voltage to turn a pixel TFT off, a person of ordinary skill in the art would recognize that these high/low gate line voltage designations can be reversed depending on the particular type of TFT used.

At time T1, data can be written to sub-pixels 620 and 670 by turning pixel TFTs 622 and 672, respectively, on and applying a target voltage to data lines 640 and 690, respectively. This process is similar to the one described above with respect to sub-pixels 610 and 660. Timing control module 602 can generate a control signal to indicate that pixel TFTs 622 and 672 should be turned on. This control signal can also indicate that pixel TFTs 612, 632, 662, and 682 can be turned off. Based on this control signal, gate driver 604 can apply a voltage, for example a high gate line voltage, to gate line 606 to turn pixel TFTs 622 and 672 on. Gate driver 604 can apply a different voltage, for example a low gate line voltage, to gate lines 605 and 607 to turn pixel TFTs 612, 632, 662, and 682 off.

Once pixel TFTs 622 and 672 are turned on, source amplifiers 645 and 695 can apply target voltages to data lines 640 and 690, respectively, at substantially the same time. These target voltages can be transmitted to the source terminals of pixel TFTs 622 and 672 via data line extensions 621 and 671, respectively. Because pixel TFTs 622 and 672 can be turned on, the target voltages applied to the source terminals of both pixel TFTs can conduct through the transistors and onto pixel electrodes 624 and 674, respectively. The difference in voltage between the pixel electrode (624, 674) and common electrode (626, 676) in liquid crystal capacitors 628 and 678 can create an electric field through the liquid crystal that can influence the orientation of the liquid crystal and affect the resulting luminance of sub-pixels 620 and 670. While data is written to sub-pixels 620 and 670, sub-pixels 610, 630, 660, and 680 can be turned off.

Visual artifacts may not appear in the exemplary embodiment of FIG. 6 because there are no floating data lines connected to the pixel TFTs. This effect can occur because of the following reasons.

First, the data lines in the exemplary embodiment of FIG. 6 may not be floating. This effect can be explained with reference to the write sequence described above. In this example write sequence, data is first written to sub-pixels 610 and 660 at time T0 and subsequently written to sub-pixels 620 and 670 at time T1. At time T0, source amplifier 645 can apply a target voltage to data line 640 which can create a large change in voltage on the data line due to, for example, the particular inversion scheme being implemented. Although a mutual capacitance exists between data lines 640 and 690, the change in voltage on data line 640 cannot affect the voltage on data line 690 because a target voltage can be applied to data line 690 at substantially the same time that a voltage is applied to data line 640 (i.e., data line 690 is not floating). For similar reasons, data line 640 may not be floating when source amplifier 695 applies a voltage to data line 690. The same effects can be observed at time T1 because source amplifier 645 can apply a voltage to data line 640 at substantially the same time that source amplifier 695 applies a voltage to data line 690.

Second, when data is not written to a sub-pixel, its corresponding pixel TFT can be turned off The consequences of this effect can be explained with reference to the write sequence described above. At time T0, for example, source amplifier 645 can write data to sub-pixel 610 by applying a target voltage to data line 640. At this time, gate driver 604 can apply a high gate line voltage on gate line 605 to turn pixel TFT 612 on. Because a low gate line voltage is applied to gate lines 606 and 607, pixel TFTs 622 and 632 and corresponding sub-pixels 620 and 630, respectively, can be turned off. If the circuit of FIG. 6 were modified such that sub-pixels 620 and 630 were each connected to a data line (not shown), the change in voltage on data line 640 would not yield visual artifacts in sub-pixels 620 and 630. Although the voltage on these floating data lines (not shown) can be perturbed when the voltage on data line 640 swings, pixel TFTs 622 and 632 are electrically disconnected from their floating data lines because a low gate line voltage is applied to gate lines 606 and 607. Because pixel TFTs 622 and 632 are electrically disconnected from their data lines, any perturbation in voltage on these data lines cannot affect sub-pixels 620 and 630.

One or more of the functions of the above embodiments including, for example, the application of voltage in accordance with a write sequence can be performed by computer-executable instructions, such as software/firmware, residing in a medium, such as a memory, that can be executed by a processor, as one skilled in the art would understand. The software/firmware can be stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “non-transitory computer-readable storage medium” can be any physical medium that can contain or store the program for use by or in connection with the instruction execution system, apparatus, or device. The non-transitory computer-readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like. In the context of this document, a “non-transitory computer-readable storage medium” does not include signals.

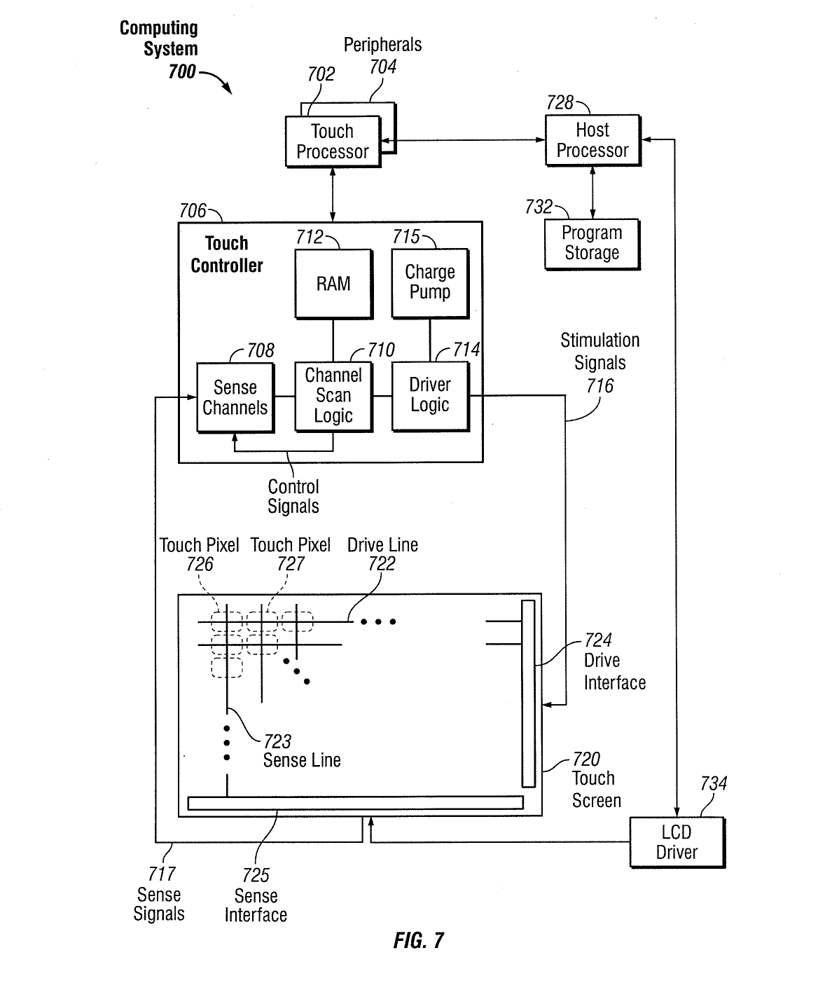

FIG. 7 is a block diagram of an example computing system 700 that illustrates one implementation of an example display screen according to embodiments of the disclosure. In the example of FIG. 7, the computing system is a touch sensing system 700 and the display screen is a touch screen 720, although it should be understood that the touch sensing system is merely one example of a computing system, and that the touch screen is merely one example of a type of display screen. Computing system 700 could be included in, for example, mobile telephone 136, digital media player 140, personal computer 144, or any mobile or non-mobile computing device that includes a touch screen. Computing system 700 can include a touch sensing system including one or more touch processors 702, peripherals 704, a touch controller 706, and touch sensing circuitry (described in more detail below). Peripherals 704 can include, but are not limited to, random access memory (RAM) or other types of memory or non-transitory computer-readable storage media capable of storing program instructions executable by the touch processor 702, watchdog timers and the like. Touch controller 706 can include, but is not limited to, one or more sense channels 708, channel scan logic 710 and driver logic 714. Channel scan logic 710 can access RAM 712, autonomously read data from the sense channels and provide control for the sense channels. In addition, channel scan logic 710 can control driver logic 714 to generate stimulation signals 716 at various frequencies and phases that can be selectively applied to drive regions of the touch sensing circuitry of touch screen 720. In some embodiments, touch controller 706, touch processor 702 and peripherals 704 can be integrated into a single application specific integrated circuit (ASIC). A processor, such as touch processor 702, executing instructions stored in non-transitory computer-readable storage media found in peripherals 704 or RAM 712, can control touch sensing and processing, for example.

Computing system 700 can also include a host processor 728 for receiving outputs from touch processor 702 and performing actions based on the outputs. For example, host processor 728 can be connected to program storage 732 and a display driver, such as an LCD driver 734. Host processor 728 can use LCD driver 734 to generate an image on touch screen 720, such as an image of a user interface (UI), by executing instructions stored in non-transitory computer-readable storage media found in program storage 732, for example, to control the demultiplexers, voltage levels and the timing of the application of voltages as described above. In other embodiments the touch processor 702, touch controller 706, or host processor 728 may independently or cooperatively control the demultiplexers, voltage levels and the timing of the application of voltages. Host processor 728 can use touch processor 702 and touch controller 706 to detect and process a touch on or near touch screen 720, such a touch input to the displayed UI. The touch input can be used by computer programs stored in program storage 732 to perform actions that can include, but are not limited to, moving an object such as a cursor or pointer, scrolling or panning, adjusting control settings, opening a file or document, viewing a menu, making a selection, executing instructions, operating a peripheral device connected to the host device, answering a telephone call, placing a telephone call, terminating a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. Host processor 728 can also perform additional functions that may not be related to touch processing.

Touch screen 720 can include touch sensing circuitry that can include a capacitive sensing medium having a plurality of drive lines 722 and a plurality of sense lines 723. It should be noted that the term “lines” is sometimes used herein to mean simply conductive pathways, as one skilled in the art will readily understand, and is not limited to elements that are strictly linear, but includes pathways that change direction, and includes pathways of different size, shape, materials, etc. Drive lines 722 can be driven by stimulation signals 716 from driver logic 714 through a drive interface 724, and resulting sense signals 717 generated in sense lines 723 can be transmitted through a sense interface 725 to sense channels 708 (also referred to as an event detection and demodulation circuit) in touch controller 706. In this way, drive lines and sense lines can be part of the touch sensing circuitry that can interact to form capacitive sensing nodes, which can be thought of as touch picture elements (touch pixels), such as touch pixels 726 and 727. This way of understanding can be particularly useful when touch screen 720 is viewed as capturing an “image” of touch. In other words, after touch controller 706 has determined whether a touch has been detected at each touch pixel in the touch screen, the pattern of touch pixels in the touch screen at which a touch occurred can be thought of as an “image” of touch (e.g. a pattern of fingers touching the touch screen).

In some example embodiments, touch screen 720 can be an integrated touch screen in which touch sensing circuit elements of the touch sensing system can be integrated into the display pixels stackups of a display.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

What is claimed is:

1. A display apparatus, comprising:
an array of pixels, each pixel associated with a plurality of sub-pixels, each sub-pixel associated with a data line;
a display driver that sequentially applies voltage to the data lines in each pixel in accordance with a write sequence; and
a plurality of electrically conductive guard lines, each guard line positioned between two adjacent data lines.

2. The display apparatus of claim 1, wherein each guard line is connected to a reference potential.

3. The display apparatus of claim 2, wherein the reference potential is connected to ground or AC ground.

4. The display apparatus of claim 1, wherein the adjacent data lines belong to the same pixel.

5. The display apparatus of claim 1, wherein the adjacent data lines include a first data line and a second data line, the first and second data lines each belonging to a different pixel.

6. The display apparatus of claim 1, wherein the display apparatus is integrated within a computing system.

7. A method for displaying an image on a display apparatus having an array of pixels, each pixel associated with a plurality of sub-pixels, each sub-pixel associated with a data line, the method comprising:
sequentially applying a voltage to the data lines in the pixel in accordance with a write sequence; and
shielding electric field lines between two adjacent data lines with an electrically conductive guard line positioned between the adjacent data lines.

8. The method of claim 7, further comprising connecting each guard line to a reference potential.

9. The method of claim 8, wherein the reference potential is connected to ground or AC ground.

10. The method of claim 7, wherein the adjacent data lines belong to the same pixel.

11. The method of claim 7, wherein the adjacent data lines include a first data line and a second data line, the first and second data lines each belonging to a different pixel.

12. A display apparatus, comprising:
an array of pixels, each pixel associated with one of a plurality of data lines, each pixel including a plurality of sub-pixels, each sub-pixel associated with a gate line and including a pixel TFT connected to the data line and to the gate line;
a timing control module configured to generate a control signal, the control signal identifying a sub-pixel to be turned on and a plurality of sub-pixels to be turned off; and
a gate driver configured to selectively apply a voltage to a gate line of the sub-pixel to be turned on based on the control signal,
wherein a pixel TFT of the sub-pixel to be turned on is electrically connected to the data line, and
wherein pixel TFTs of the plurality of sub-pixels to be turned off are electrically disconnected from the data line.

13. The display apparatus of claim 12, further comprising a plurality of source amplifiers, individual ones of the source amplifiers connected to different ones of the plurality of data lines, each source amplifier applying a voltage to the data line in accordance with a write sequence.

14. The display apparatus of claim 13, wherein each source amplifier applies a voltage to the data line at substantially the same time.

15. The display apparatus of claim 12, wherein the control signal is a clock pulse.

16. The display apparatus of claim 12, wherein each sub-pixel further includes a liquid crystal capacitor having a pixel electrode and a common electrode.

17. The display apparatus of claim 16, wherein the pixel electrode is connected to the pixel TFT.

18. The display apparatus of claim 12, wherein the pixel TFT is connected to the data line via a data line extension.

19. The display apparatus of claim 12, wherein the pixel is associated with only a single data line.

20. The display apparatus of claim 12, wherein the display apparatus is integrated within a computing system.

21. A method for displaying an image on a display apparatus having an array of pixels, each pixel associated with one of a plurality of data lines, each pixel including a plurality of sub-pixels, each sub-pixel associated with a gate line and including a pixel TFT connected to the data line and to the gate line, the method comprising:
generating a control signal, the control signal identifying a sub-pixel to be turned on and a plurality of sub-pixels to be turned off; and
selectively applying a voltage to a gate line of the sub-pixel to be turned on based on the control signal,
wherein a pixel TFT of the sub-pixel to be turned on is electrically connected to the data line, and
wherein pixel TFTs of the plurality of sub-pixels to be turned off are electrically disconnected from the data line.

22. The method of claim 21, further comprising applying voltages to the data lines in accordance with a write sequence.

23. The method of claim 22, wherein the voltages are applied to the data lines at substantially the same time.
